(19) United States
(12) Patent Application Publication
(10) Pub. No.: US 2002/0113585 A1
(43) Pub. Date: Aug. 22, 2002

(54) Frequency converter system having a damping device with a passive, static impedance for damping undesirable resonant oscillations in a tuned circuit formed by at least one input-side inductance and parasitic distributed capacitances

(76) Inventors: Reinhold Dillig, Memmelsdorf (DE); Bernd Segger, Erlangen (DE); Roland Steinmueller, Erlangen (DE)

Correspondence Address: BAKER & BOTTS, 30 ROCKEFELLER PLAZA, NEW YORK, NY, 10112

(21) Appl. No.: 09/918,004

(22) Filed: Jul. 30, 2001

(30) Foreign Application Priority Data
Dec. 22, 2000 (DE) 100 642 13.6

(51) Int. Cl. H01F 17/00

(52) U.S. Cl. 323/355

(57) ABSTRACT

The invention relates to a frequency converter system having a filter, an input-side inductance, in particular a supply network-side (or input) inductor, and a converter having an input converter and an inverter for supplying an electrical machine. The frequency converter constitutes a tuned circuit formed by at least one input-side inductance and parasitic distributed capacitances in the frequency converter system, with undesirable resonant oscillations encountered during operation of the frequency converter system, with a damping device being provided for damping the tuned circuit.

### BACKGROUND OF THE INVENTION

In present-day frequency converter systems having an intermediate voltage circuit, in particular in multi-shaft converter systems, system oscillations can form which are virtually undamped. This is especially true in frequency converters having an intermediate voltage circuit and a regulated supply in the form of a supply network-side converter, which is also referred to as an input converter.

Frequency converters are used for operating electrical machines with a variable supply frequency. Such a frequency converter allows an electric motor, for example a three-phase motor such as a synchronous motor, to be operated not only in such a manner that it is linked directly to the supply network and hence has a fixed rotation speed, but also so that the fixed supply network can be replaced (at least from the point of view of the motor) by an electronically produced, variable-frequency and variable-amplitude supply for powering the electrical motor.

The two supply systems, (ie. the supply network where the amplitude and frequency are fixed, and the variable supply system which supplies the electrical motor with a variable amplitude and frequency), are coupled via a DC voltage storage device, or a DC current storage device in the form of what is referred to as an intermediate circuit. In this case, such intermediate circuit converters essentially have three main assemblies:

a supply network-side input converter which can be designed to be unregulated (for example diode bridges) or to be regulated, in which case energy can be fed back into the supply network only by using a regulated input converter;

an energy storage device in the intermediate circuit in the form of a capacitor in the case of an intermediate voltage circuit and an inductor in the case of an intermediate current circuit; and

an output-side converter or inverter for supplying the motor, which generally uses a three-phase bridge circuit having six active current devices which can be turned off, for example IGBT transistors, to convert the DC voltage in the intermediate voltage circuit into a three-phase voltage system.

Such a frequency converter system (converter system), having an intermediate voltage circuit, which is preferably used for main and servo drives in machine tools, robots and production machines, hereinafter machines, inter alia owing to a very high frequency and amplitude control range, is shown in FIG. 1. The frequency converter UR, is connected via a filter F and an input-side inductance, namely a supply network-side input inductor L_{K}, to a three-phase supply network N having three supply phase lines L₁, L₂ and L₃. The converter UR comprises the input converter E, an intermediate voltage circuit with an energy-storage capacitance C_{ZK}, and an output inverter W.

FIG. 1 shows a regulated input converter E which is operated such that it is controlled by switching components (for example a three-phase bridge circuit composed of IGBT transistors), as a result of which the arrangement as shown in FIG. 1 experiences excitation A1. The inverter W is likewise regulated via further switching components, for example, by means of a three-phase bridge circuit having six IGBT transistors. The switching operations that take place in the inverter W are represented by system excitation function A2. The capacitor C_{ZK} in the intermediate voltage circuit is connected between the positive intermediate circuit rail P600 and the negative intermediate circuit rail M600. The inverter is connected on the output side to line LT, having a protective-ground conductor PE and a shield SM, to a three-phase machine such as motor M.

A fixed-frequency three-phase supply network N supplies the intermediate circuit capacitor C_{ZK} via the input converter E and via the filter F, and the storage system input inductor L_{K} by means of the controlled supply, with the input converter E (for example a pulse-controlled converter) operating together with the energy storage input inductor L_{K} as a step-up converter. Once current flows into the supply network-side input inductor L_{K}, it is fed to the intermediate circuit and into capacitor C_{ZK}. The intermediate circuit voltage may therefore be greater than the peak value of the supply network voltage. This combination therefore effectively represents a DC voltage source. The inverter W uses this DC voltage in the described manner to form a three-phase supply voltage network where, in contrast to the sinusoidal voltage of a three-phase generator, the output voltage does not have the profile of an ideal sinusoidal oscillation, but includes harmonics in addition to the fundamental, since it is produced electronically via a bridge circuit.

In addition to the described elements in such an arrangement, it is also necessary to take into account the fact that parasitic capacitances are present which assist the formation of system oscillations in such a converter system. Thus, in addition to the filter F with a discharge capacitance C_{F}, the input converter E, the inverter W and the motor M also have discharge capacitances C_{E}, C_{W} and C_{M} to ground. Furthermore, there is a capacitance C_{PE} in the line LT to the protective-ground conductor PE, and a capacitance C_{SM} in the line LT to the grounded shield SM.

Particularly pronounced excitation of these system oscillations occurs in the converter E. Depending on the control method chosen for the converter, two or three phases of the supply network N are short-circuited, in order to pass current to the energy-storage inductor L_{K}. If all three phases L₁, L₂, L₃ are short-circuited, then either the positive intermediate circuit rail P600 or the negative intermediate circuit rail M600 is hard-connected to the start point of the supply network (generally close to ground potential depending on the zero phase-sequence system component). If two phases of the supply network N are short-circuited, then the relevant intermediate circuit rails P600 and M600 are hard-connected to an inductive voltage divider between the supply network phase lines.

Depending on the status of the supply network line voltages, the voltage is in the vicinity of the ground potential (approximately 50-60 V). Since the intermediate circuit capacitance C_{ZK} is generally large (continuous voltage profile), the other intermediate circuit rail is 600 V higher or lower and can thus break down the remaining phase of the supply network. In both cases, the intermediate circuit is severely disturbed from its “natural” balanced steady-state position (±300 V with respect to ground), which excite system oscillation. With respect to the production of undesirable system oscillations, the frequency band below 50 to 100 kHz, which is relevant for the application area, allows resonant frequency to be calculated based on concentrated elements. In this case, the discharge capacitances C_{F} to ground in the filter F are generally so large that they do not have a frequency-governing effect.

The resonant frequency fᵣₑₛ(sys) of this system, which is referred to as f_{sys} in the following text, is thus given by:

$${f}_{sys} = \frac{1}{2 π \sqrt{{L}_{Σ} {C}_{Σ}}}$$

where

L_{Σ}=L_{K}+L_{F},

with L_{K} representing the dominant component and L_{F} the unbalanced inductive elements acting on the converter side in the filter (for example current-compensated inductors), and

C_{Σ}=C_{E}+C_{W}+C_{PE}+C_{SM}+C_{M}.

This relationship is shown in FIG. 2. In this case, L_{Σ} and C_{Σ} form a passive circuit, which is excited by excitation A and starts to oscillate at its natural resonant frequency f_{sys}.

Consequently, in addition to the voltage swings having an amplitude of 600 V, for example, that occur during operation, an additional undesirable resonant oscillation with an amplitude of up to several hundred volts is also modulated onto the voltage levels on the intermediate circuit rails P600 and M600. These undesirable resonant oscillations result in a number of adverse effects in the frequency converter system.

Any unbalanced current which occurs produces losses when it flows through the input inductor L_{K}, and this results in an undesirable and considerable increase in the temperature of the input inductor L_{K}. The undesirable resonant oscillation results in the intermediate circuit being disturbed considerably further from its steady state position than that caused by the switching operations of the input converter E itself. This can endanger the insulation in the motor M. Since the damping in the resonant tuned circuit is weak, large unbalanced peak current values occur and can lead to saturation of the magnetic components in the filter F.

### SUMMARY OF THE INVENTION

It is an object of the present invention to provide a frequency converter system having a tuned circuit formed by at least one input-side inductance and parasitic distributed capacitances in the frequency converter system, whereby any undesirable resonant oscillations are damped.

In a preferred embodiment of the present invention, a frequency converter system is provided with a damping device for damping the tuned circuit to minimize any undesirable system oscillations. The damping device has a damping element and a connecting element connected to it for transformer coupling of the damping element (similar to the principle of a current-compensated inductor) to the frequency converter system.

According to a preferred embodiment of the present invention, the connecting element is connected to the input-side inductance, or is integrated into it. The magnetic energy produced by the unbalanced current resulting from the resonant oscillation is thus extracted in the input-side inductance, and the damping element is introduced into the input-side inductance without interfering with the power flow in the frequency converter system.

The damping element that is introduced thus affects only the zero phase-sequence system of the frequency converter system, while the positive phase-sequence system, together with the power transmission to the electrical motor is not affected.

In a further preferred embodiment of the connecting element, the input-side inductance is in the form of a four-limb inductor, and the three supply network phases of the frequency converter system together with the damping element are respectively connected to one limb of the four-limb inductor.

In yet another preferred embodiment, the input-side inductance is likewise in the form of a four-limb inductor, and the three supply network phases are respectively connected to one limb of the four-limb inductor, and are jointly connected to the fourth limb of the four-limb inductor. The damping element is connected only to the fourth limb. This results in improved coupling, since less stray inductance is present.

In another preferred embodiment, the input-side inductance is in the form of a three-limb inductor, and the three supply network phase lines are respectively connected to one limb of the inductor. The non-reactive resistance is introduced into the input-side inductance via additional windings which are fitted on each individual limb of the three-limb inductor. This results in a very high coupling level.

A filter element, for example a capacitance which is connected in series with the damping element, can be used to ensure that only the alternating-current components in the zero phase-sequence system flow via the damping element. This helps to prevent magnetic unbalances for example resulting from parameter tolerances.

The damping element is advantageously in the form of a passive static impedance and, in particular, in the form of a non-reactive resistance for transformer coupling into the frequency converter system.

### BRIEF DESCRIPTION OF THE DRAWINGS

The invention will be explained in more detail with reference to exemplary embodiments in the drawing, in which:

FIG. 1 shows a block diagram of a frequency converter system having a three-phase motor, using a converter with an intermediate voltage circuit and a controlled input converter, together with at least one input-side inductance;

FIG. 2 shows a single-phase equivalent circuit of the passive circuit formed by the arrangement of a converter system as shown in FIG. 1, with regard to system oscillations with respect to ground;

FIG. 3 shows a first embodiment of a four-limb inductor for the frequency converter system according to the invention;

FIG. 4 shows a further embodiment of a four-limb inductor; and

FIG. 5 shows a schematic illustration of a three-limb inductor for the frequency converter system according to the invention.

### DETAILED DESCRIPTION OF THE INVENTION

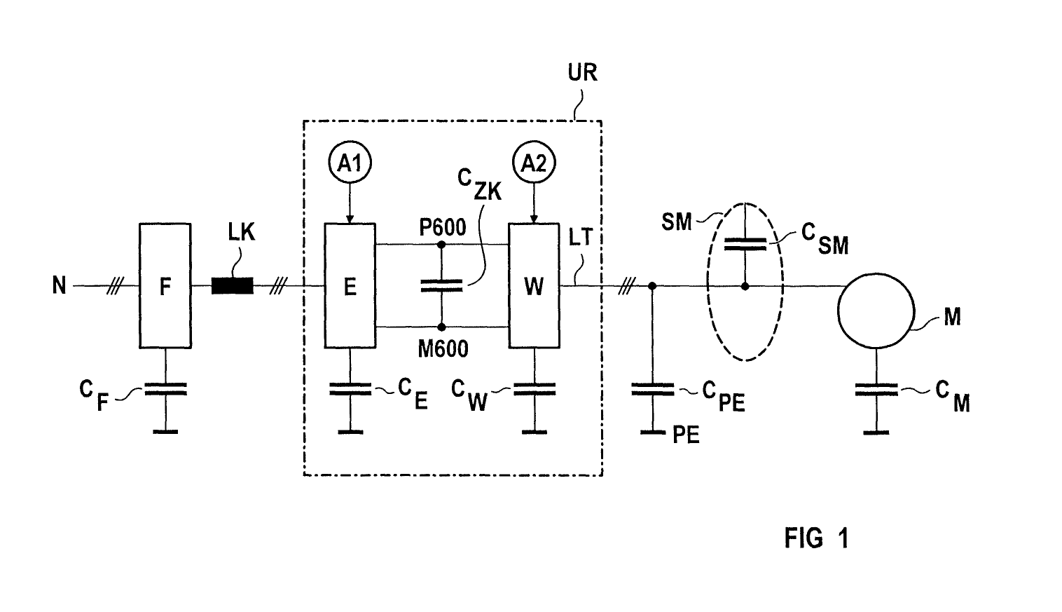

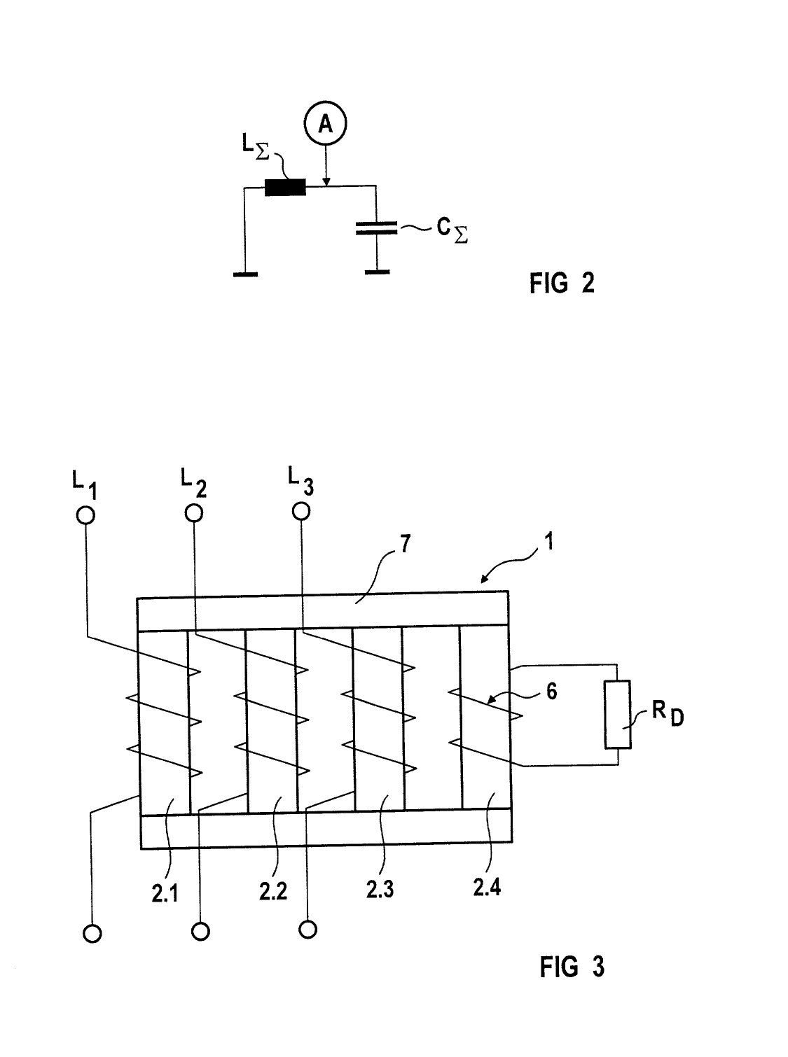

FIG. 1 and FIG. 2 have already been explained in detail in the background description and also illustrate the schematic design of the frequency converter system according to the invention. FIG. 3 shows a supply network input inductor L_{K} as the input-side inductance for a converter system as shown in FIG. 1, which is in the form of a four-limb inductor 1, with the three supply network phase lines L₁, L₂ and L₃, each being wound on a respective limb 2.1, 2.2, 2.3 of the four-limb inductor 1.

The non-reactive resistance R_{D}, which is used as the damping element, is connected via the winding 6 (connecting element) to the fourth limb 2.4 of the four-limb inductor 1, with the undesirable system oscillations being damped via the closed core 7 (for example an iron core) of the four-limb inductor 1.

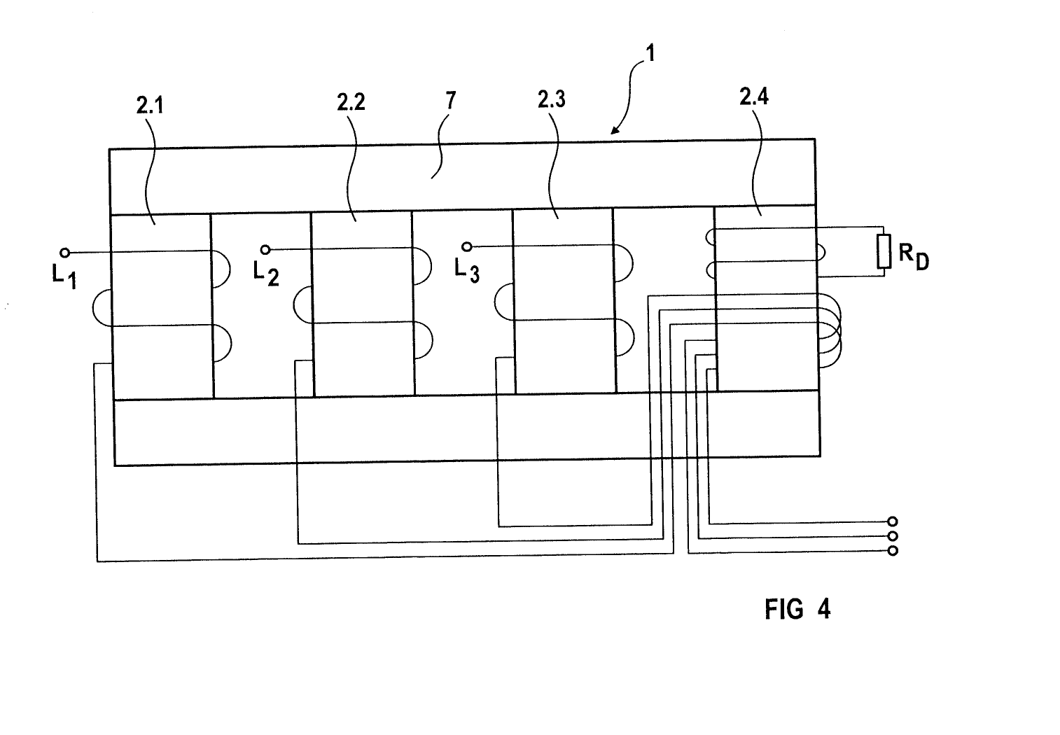

In FIG. 4, the input-side inductance is likewise in the form of a four-limb inductor 1, with the supply network phase lines L₁, L₂ and L₃ wound individually around an associated one of the first three limbs 2.1, 2.2, 2.3 of the four-limb inductor 1, and then jointly wound around the fourth limb 2.4 of the four-limb inductor 1. In this case, the winding of the three supply network phase lines L₁, L₂ and L₃ over the fourth limb 2.4 of inductor 1 is illustrated schematically, and may include a number of additional turns around the fourth limb 2.4 (not shown). The non-reactive resistance R_{D} is also wound as the damping element over the fourth limb 2.4, resulting in better coupling than the embodiment shown in FIG. 3. The effectiveness of the damping is increased by the non-reactive resistance R_{D}.

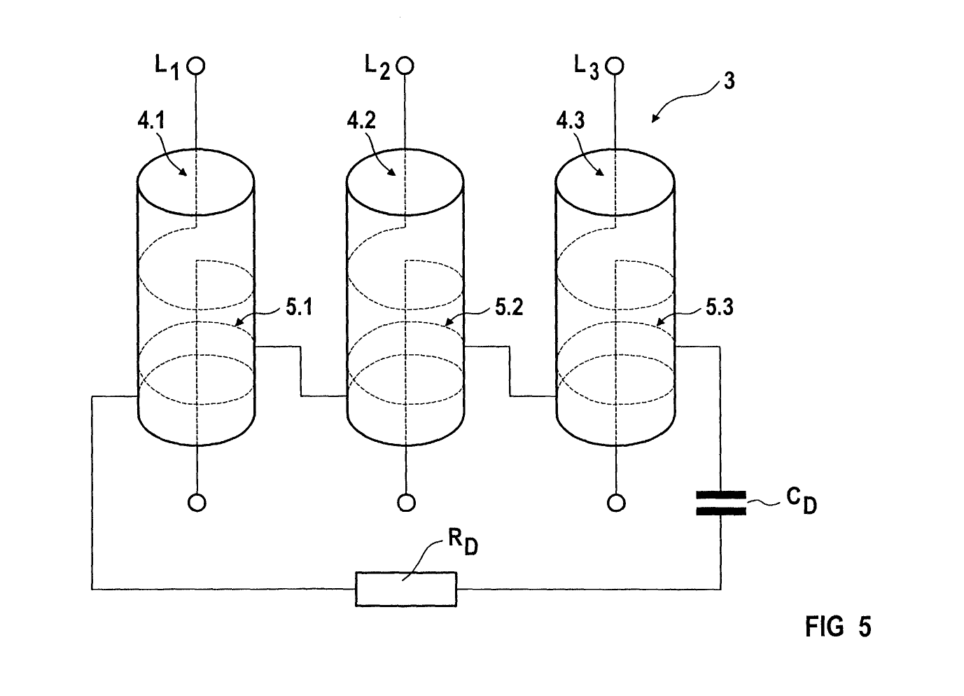

In FIG. 5, the input-side inductance is in the form of a three-limb inductor 3 (without a closed core), with the three supply network phase lines L₁, L₂ and L₃ each being wound over a respective one of the three limbs 4.1, 4.2 and 4.3. The non-reactive resistance R_{D} which is used as the damping element is introduced via additional windings 5.1, 5.2, 5.3, which are used as the connecting element, to a respective limb 4.1, 4.2, 4.3 of the inductor 3, with the additional windings 5.1, 5.2, 5.3 being connected in series. This results in one further additional winding 5.1, 5.2, 5.3 in each case being fitted on each individual winding of the three supply network phase lines L₁, L₂ and L₃ of the inductor 3, so that the coupling level is increased. Any undesirable system oscillations are effectively damped by the non-reactive resistance R_{D}.

A filter element, for example a capacitance C_{D}which is connected in series with the non-reactive resistance R_{D}, makes it possible to ensure that only the alternating-current components in the zero phase-sequence system flow to the damping element. This helps to prevent magnetic unbalances, for example due to parameter tolerances.

The foregoing illustrates the principles of the invention in the context of preferred embodiments. Various modifications and alterations to the described embodiments will be apparent to those skilled in the art in view of the teachings herein. It will thus be fully appreciated that those skilled in the art will be able to devise numerous systems and methods which, although not explicitly shown or described, embody the principles of the invention and thus are within the spirit and scope of the invention as defined in the appended claims.

We claim:

1. A frequency converter system having associated parasitic capacitances comprising at least one input-side inductance; at least one frequency converter having an input converter coupled to said input-side inductance and an inverter coupled to said input converter for supplying an electrical machine; and at least one damping device for damping undesirable resonant oscillations encountered during operation of said frequency converter system, said resonant oscillations associated with said at least one input-side inductance and said parasitic capacitances.

2. The frequency converter system according to claim 1, wherein said damping device further comprises a damping element and a coupling element for coupling said damping element to said frequency converter system.

3. The frequency converter system according to claim 2, wherein said damping element is transformer-coupled via said coupling element to said frequency converter system.

4. The frequency converter system according to claim 2, wherein said coupling element is coupled to said input-side inductance.

5. The frequency converter system according to claim 4, wherein said coupling element is part of said input-side inductance.

6. The frequency converter system according to claim 5, wherein said input side inductance is coupled to a supply network having a first, second and third phase lines; said input-side inductance is a four-limb inductor having a first, second, third and fourth limbs; and said first phase line is coupled to said first limb, said second phase line is coupled to said second limb, said third phase line is coupled to said third limb and said damping element is coupled to said fourth limb.

7. The frequency converter system according to claim 5, wherein said input side inductance is coupled to a supply network having a first, second and third phase lines; said input-side inductance is a four-limb inductor having a first, second, third and fourth limbs; and said first phase line is coupled to said first and fourth limb, said second phase line is coupled to said second and fourth limb, said third phase line is coupled to said third and fourth limb and said damping element is connected to the fourth limb of said inductor.

8. The frequency converter system according to claim 5, wherein said input side inductance is coupled to a supply network having a first, second and third phase lines; said input-side inductance is in a three-limb inductor having a first, second and third limbs; and said first phase and said damping element are coupled to said first limb, said second phase line and said damping element are coupled to said second limb and said third phase line and said damping element are coupled to said third limb.

9. The frequency converter system according to claim 2, wherein said damping device further comprises a filter element connected in series with said damping element.

10. The frequency converter system according to claim 9, wherein said filter element is a capacitance element.

11. The frequency converter system according to claim 2, wherein said damping element is a passive, static impedance element.

12. The frequency converter system according to claim 11, wherein said passive, static impedance is a non-reactive resistance element.
